(19) United States
(12) Patent Application Publication
(10) Pub. No.: US 2026/0245121 A1
(43) Pub. Date: Aug. 20, 2026

(54) COMPUTERIZED-SYSTEM AND COMPUTERIZED-METHOD FOR GENERATIVE ARTIFICIAL INTELLIGENCE BASED DIGITAL CHANNEL SELECTION OF OUTBOUND CAMPAIGN COMMUNICATION, TO A PRODUCT OF A TENANT, IN A CLOUD-BASED CONTACT CENTER

(71) Applicant: NICE LTD., Ra'anana (IL)

(72) Inventors: Salil DHAWAN, Pune (IN); Nishu BANSAL, Pune (IN); Ashish KHATRI, Pune (IN)

(21) Appl. No.: 19/056,807

(22) Filed: Feb. 19, 2025

(51) Int. Cl. G06Q 30/02; G06F 40/30

(52) U.S. Cl. CPC G06Q 30/0281; G06F 40/30

(57) ABSTRACT

A computerized-system for generative artificial intelligence based digital channel selection of outbound campaign communication, to a product of a tenant, in a cloud-based contact center. The computerized-system includes a contact center datastore; a product Customer Relationship Management (CRM) datastore; a memory to store the plurality of datastores; and processors. For each interaction of the outbound campaign the processors are configured to: (i) generate contextual word embeddings for contact center data of the tenant retrieved from the contact center datastore and data of the product of the tenant retrieved from the product CRM datastore; (ii) calculate a Channel Selection Score (CSS) of each digital channel in one or more digital channels of the tenant based on the generated contextual embeddings; (iii) select a digital channel having highest CSS from the one or more digital channels; and (iv) automatically redirect the outbound campaign communication via the selected digital channel.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of generative artificial intelligence based digital channel selection of outbound campaign communication, to a product of a tenant, in a cloud-based contact center.

### BACKGROUND

In contact centers, where agents engage across digital channels, the pivotal Conversion Rate is monitored to gauge lead quality. Yet, traditional methods struggle with manual channel selection, leading to lower conversion rates amid evolving customer preferences.

There is a need for a technical solution that will leverage generative Artificial Intelligence (AI) to select optimal communication channels, analyze historical data, predict behaviors, and adapt in real time. Manual channel selection in digital outbound communication can be cumbersome, inefficient, and error-prone. It can lead to a poor customer experience, scalability issues, missed optimization opportunities, and increased costs.

For businesses handling large volumes of outbound communications, automation and channel selection are crucial to improving efficiency, customer satisfaction, and overall performance. Manually selecting which channel to use for each customer interaction may be time-consuming and prone to errors. For instance, if an agent has to decide whether to send an email, Short Message Service (SMS), or make a call for each customer individually, it may lead to inefficiencies and delays.

In current systems, there's often no automated process to suggest or select the best channel based on the customer's preferences or the nature of the communication. This requires human intervention, which slows down the overall process and increases the chances of mistakes.

There is a need for a technical solution to automate selection of most suitable digital channel for each customer. For example, a situation where a customer who prefers to handle communications via email but instead receives an SMS or a voice call from an agent, may not result in a desired outcome in an outbound campaign communication. Also, manual selection doesn't always account for customer history, preferences, or the context of the interaction. Automated systems, on the other hand, can dynamically choose the most suitable digital channel based on past interactions, ensuring a more personalized experience, such that the outbound campaign may result in a better conversion rate.

As the volume of outbound communication grows, manual channel selection becomes increasingly difficult to manage. Human agents may not be able to efficiently select the best channels for thousands of interactions, especially during peak times. Also, manual processes are not easily scalable. As the business grows or customer communication channels multiply, the manual process of selecting a channel for each interaction becomes less feasible. Therefore, automation is key to scaling customer outreach while maintaining quality.

Another disadvantage of manual channel selection is that is doesn't leverage available customer data, like past communication history or preferences. An automated system, in contrast, can use data analytics to optimize channel selection, ensuring that the right channel is used at the right time for each customer. Moreover, there may be missed opportunities for optimization as with manual selection, businesses miss out on opportunities to analyze and refine their communication strategies. Unlike automated systems which can continuously learn from data, improving channel selection over time.

Manual channel selection can lead to inconsistent or inaccurate tracking of communication efforts. Automated systems can consolidate all data into a unified dashboard, making it easier to track which channels are most effective, what communication strategies work best, and where improvements are needed. With manual selection, it's harder to have a centralized view of all interactions across channels. This makes it difficult to gain insights into the effectiveness of different channels and to maintain consistency in customer outreach.

Manual selection often results in a fragmented approach to communication. For example, a customer might receive an SMS followed by an email, and then a call, leading to disjointed and potentially confusing interactions. An automated, omnichannel approach will ensure that customers receive consistent messaging across all channels. Inability to seamlessly switch between channels may be solved by an omnichannel approach allows for easy switching between channels based on customer behavior, e.g., moving from an email to a phone call if the customer engages with the email.

### SUMMARY

There is thus provided, in accordance with some embodiments of the present disclosure, a computerized-system for generative artificial intelligence based digital channel selection of outbound campaign communication, to a product of a tenant, in a cloud-based contact center.

In accordance with some embodiments of the present disclosure, the computerized-system may include a contact center datastore; a product Customer Relationship Management (CRM) datastore; a memory to store the plurality of datastores; and one or more processors.

Furthermore, in accordance with some embodiments of the present disclosure, for each interaction of the outbound campaign, the one or more processors may be configured to: (i) generate contextual word embeddings for contact center data of the tenant retrieved from the contact center datastore and data of the product of the tenant retrieved from the product CRM datastore; (ii) calculate a Channel Selection Score (CSS) of each digital channel in one or more digital channels of the tenant based on the generated contextual embeddings; (iii) select a digital channel having highest CSS from the one or more digital channels; and (iv) automatically redirect the outbound campaign communication via the selected digital channel.

Furthermore, in accordance with some embodiments of the present disclosure, the contact center data retrieved from the contact center datastore may include interactions-data related to outbound campaign communication during a preconfigured period. The interactions-data may include at least one of: (i) digital channel used; (ii) customer data; (iii) result of the outbound campaign communication; and (iv) transcript. The data of the product retrieved from the product CRM datastore comprising description of the product.

Furthermore, in accordance with some embodiments of the present disclosure, the generating contextual word embeddings may be performed by using neural networks to capture word-level semantics and a continuously trained Artificial Intelligence (AI) language model to capture context-sensitive embeddings. For example, utilizing Word2Vec neural networks and Gen AI to generate the word embeddings. The AI language model may be for example, Bidirectional Encoder Representations from Transformers (BERT) models.

Furthermore, in accordance with some embodiments of the present disclosure, the contact center data retrieved from the contact center datastore, and the data of the product retrieved from the product CRM datastore may be cleaned and normalized before the generating of word embeddings.

Furthermore, in accordance with some embodiments of the present disclosure, the calculating of the CSS of each digital channel in the one or more digital channels may be performed according to formula I:

CSS=[(embedding(wi))×W1]+[CS×W2]+[CPS×W3], (I)
whereby:
embedding (wi) is a contextual embedding value of wi,
CS is Channel Sentiment score that is calculated based on sentiment analysis of the AI language model through Generative Adversarial Networks (GANs) processing,
CPS is Channel Probability Score that is derived by an ensemble learning technique, and W1, W2 and W3 are preconfigured weights and their total sum equals ‘1’. The ensemble learning technique may be for example, Boosting (AdaBoost) ensemble learning technique.

Furthermore, in accordance with some embodiments of the present disclosure, the one or more processors may be further configured to send a notification to one or more applications of the tenant with details of the CSS of each digital channel and the selected digital channel. The one or more applications are one of: (i) supervisor dashboard; (ii) reporting; (iii) Quality Management (QM); and (iv) gamification.

Furthermore, in accordance with some embodiments of the present disclosure, the CSS of each digital channel and the number of interactions that were redirected to the selected digital channel may be presented via the supervisor dashboard of the tenant.

Furthermore, in accordance with some embodiments of the present disclosure, the CSS of each digital channel may be presented via the reporting with campaign data and interaction data

Furthermore, in accordance with some embodiments of the present disclosure, the one or more processors may be further configured to monitor a conversion rate for a preconfigured period of time that the outbound campaign communication was redirected to the selected digital channel. When the conversion rate of the campaign is below a target-threshold after the preconfigured period of time, the one or more processors may be further configured to initiate a targeted agent training programs for agents assigned to the outbound campaign communication.

Furthermore, in accordance with some embodiments of the present disclosure, the one or more processors may be further configuring the QM application to filter interactions of the outbound campaign communication for evaluation based on a range of the CSS.

Furthermore, in accordance with some embodiments of the present disclosure, the one or more processors may be further configuring the gamification application to automatically send reward points to agents assigned to the outbound campaign communication when based on conversion rate and CSS.

There is further provided, in accordance with some embodiments of the present invention, a computerized-method for generative artificial intelligence based digital channel selection of outbound campaign communication, to a product of a tenant, in a cloud-based contact center.

Furthermore, in accordance with some embodiments of the present disclosure, for each interaction of the outbound campaign the computerized-method may include: (i) generating contextual word embeddings for contact center data of the tenant retrieved from a contact center datastore and data of the product of the tenant retrieved from a product CRM datastore by using one or more processors; (ii) automatically calculating a Channel Selection Score (CSS) of each digital channel in one or more digital channels of the tenant; (iii) automatically selecting a digital channel having highest CSS from the one or more digital channels; and (iv) automatically redirecting the outbound campaign communication via the selected digital channel.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a high-level diagram of a system for generative artificial intelligence based digital channel selection of outbound campaign communication, to a product of a tenant, in a cloud-based contact center, in accordance with some embodiments of the present invention;

FIG. 2 schematically illustrates a high-level diagram of a computerized-method for generative artificial intelligence based digital channel selection of outbound campaign communication, to a product of a tenant, in a cloud-based contact center, in accordance with some embodiments of the present invention;

FIG. 3 schematically illustrates a high-level diagram of a computerized-system for generative artificial intelligence based digital channel selection of outbound campaign communication, to a product of a tenant, in a cloud-based contact center, in accordance with some embodiments of the present invention;

FIG. 4 schematically illustrates a high-level workflow for generating contextual word embeddings, in accordance with some embodiments of the present invention;

FIG. 5 schematically illustrates a high-level workflow for calculating a Channel Selection Score (CSS), in accordance with some embodiments of the present invention;

FIG. 6 schematically illustrates a high-level workflow for digital channel selection based on the CSS, in accordance with some embodiments of the present invention;

FIG. 7 illustrates automated actions based on the CSS, in accordance with some embodiments of the present invention;

FIG. 8 illustrates implementation of CSS in supervisor dashboard, in accordance with some embodiments of the present invention;

FIG. 9 is an example of supervisor dashboard showing interactions redirected based on CSS, in accordance with some embodiments of the present invention;

FIG. 10 is an example of reporting of an outbound campaign details including CSS, in accordance with some embodiments of the present invention;

FIG. 11 illustrates implementation of CSS in Quality Management (QM) application, in accordance with some embodiments of the present invention;

FIG. 12 illustrates implementation of CSS in gamification application, in accordance with some embodiments of the present invention;

FIG. 13 is a high-level workflow for digital channel selection, in accordance with some embodiments of the present invention;

FIG. 14 schematically illustrates a high-level workflow for generative artificial intelligence based digital channel selection of outbound campaign communication, to a product of a tenant, in a cloud-based contact center, in accordance with some embodiments of the present invention;

FIG. 15 schematically illustrates a diagram for word embeddings, in accordance with some embodiments of the present invention; and

FIG. 16 schematically illustrates an enhanced sentiment model, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “product” as used herein refers to any predefined action related to the outbound campaign, such as customer made a purchase of the product, signed up for a service, provided feedback, or took any other desired action as a direct consequence of the outbound campaign communication.

Manual channel selection slows down the time it takes to reach out to customers during an outbound campaign. For example, agents may have to first check customer preferences and decide whether to use email, SMS, or a voice call, which may delay the outbound campaign communication process. Lack of real-time adjustments of the digital channel may be solved by automated systems which can dynamically select, and switch channels based on real-time customer responses or engagement. In a manual process, this flexibility is lost, and agents may struggle to adapt quickly to changing customer behavior. Moreover, some communication channels are subject to different regulations, e.g., phone calls, email, SMS, and the like. Manually selecting a channel for the outbound campaign without considering these regulations may result in compliance issues or penalties, especially in regions with strict data privacy or marketing regulations.

Accordingly, there is a need for a system and method for generative artificial intelligence based digital channel selection of outbound campaign communication, to a product of a tenant, in a cloud-based contact center, for each outbound interaction during the outbound campaign.

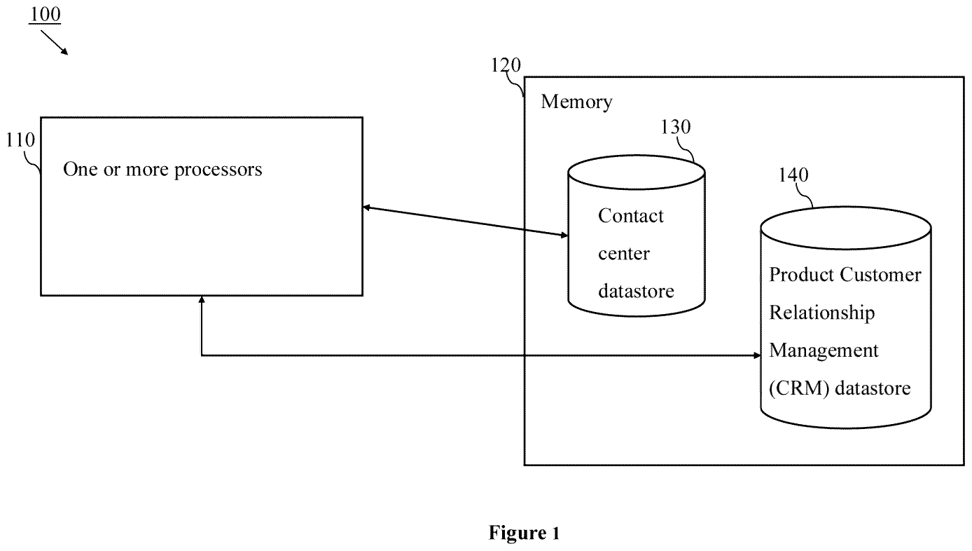

FIG. 1 schematically illustrates a high-level diagram of a system 100 for generative artificial intelligence based digital channel selection of outbound campaign communication, to a product of a tenant, in a cloud-based contact center, in accordance with some embodiments of the present invention.

According to some embodiments of the present disclosure, a system, such as system 100 may optimize digital channel selection of outbound campaign communication which may be redirected by a dynamic channel selection module to a product of a tenant, in a cloud-based contact center for each outbound interaction during the outbound campaign. By analyzing historical and real-time data, system 100 may dynamically determine the most effective channel for each interaction, for the outbound campaign considering customer preferences, past behavior, and performance metrics.

According to some embodiments of the present disclosure, system 100 may automate digital channel selection process for outbound campaign communication by using Artificial Intelligence (AI) algorithms tailored for digital channels, analyzing data and predicting behavior to enhance efficiency and boost conversion rates during the outbound campaign communication.

According to some embodiments of the present disclosure, system 100 may analyze vast amounts of historical and real-time data of the tenant to personalize digital communication channels for each outbound interaction. The selected digital channels may be the most suitable for the outbound campaign communication to improve conversion rate, to the product of the tenant, based on various parameters, such as customer preferences, past behavior, sentiment analysis, and segmentation.

According to some embodiments of the present disclosure, one or more processors 110 may be configured to generate contextual word embeddings for contact center data of the tenant which may be retrieved from the contact center datastore 130 and data of the product of the tenant retrieved from the product CRM datastore 140.

According to some embodiments of the present disclosure, system 100 may use data, tenant preferences and AI-driven decision making for generative artificial intelligence based digital channel selection of outbound campaign communication, to a product of a tenant, in a cloud-based contact center.

According to some embodiments of the present disclosure, wrong channel selection, such as sending an SMS instead of an email potentially confusing or frustrating customers. Moreover, overlooking customer preferences, may lead to inconsistent messaging and poor customer engagement.

According to some embodiments of the present disclosure, system 100 may provide real-time adaptive channel switching during the outbound campaign by the implementation of the AI-based mechanism within the dynamic channel selection module to continuously optimize and adapt the communication channel for the outbound campaign in real-time based on customer behavior, sentiment and engagement patterns.

According to some embodiments of the present disclosure, system 100 may select channels based on predefined parameters and historical data and dynamically adjust when customer preferences shift during the outbound campaign. Thus, enabling continuous learning and optimization and ensuring that customer engagement is maximized by switching to the most effective channel dynamically during the outbound campaign in real-time.

According to some embodiments of the present disclosure, system 100 may increase response rate, reduce drop-offs and may enhance customer experience by ensuring communication with each customer during the outbound campaign is operated on the most effective channel.

According to some embodiments of the present disclosure, the contact center data retrieved from the contact center datastore 130 may include interactions-data related to the outbound campaign communication during a preconfigured period. The interactions-data may include for example, digital channel used, customer data, result of the outbound campaign communication, and transcript of the interaction. The result of the outbound campaign communication may be for example, whether the customer made a purchase, signed up for a service, provided feedback, or took any desired action as a direct consequence of the outbound campaign communication.

According to some embodiments of the present disclosure, the data of the product retrieved from the product CRM datastore 140 may include description of the product.

According to some embodiments of the present disclosure, the contact center data retrieved from the contact center datastore 130, and the data of the product retrieved from the product CRM datastore 140 may be cleaned and normalized before the generating of the word embeddings.

According to some embodiments of the present disclosure, the generating of the contextual word embeddings may be performed by using neural networks to capture word-level semantics and a continuously trained AI language model to capture context-sensitive embeddings.

According to some embodiments of the present disclosure, the neural networks may be for example, neural networks Word2Vec, which capture semantic relationships between words and generates static word embeddings. The Word2Vec may be continuously trained by using either Continuous Bag of Words (CBOW) or Skip-gram models.

According to some embodiments of the present disclosure, the AI language model may be for example, Bidirectional Encoder Representations from Transformers (BERT) models, which understands context and nuance in language and generates dynamic word embeddings, i.e., the representation of a word may be changed depending on its context within a sentence.

According to some embodiments of the present disclosure, the combination of Word2vec and BERT ensures that both general semantic relationships and context-specific nuances are captured for accurate embedding generation.

According to some embodiments of the present disclosure, a Channel Selection Score (CSS) may be calculated for each digital channel in the digital channels of the tenant based on the generated contextual embeddings.

According to some embodiments of the present disclosure, the calculating of the CSS of each digital channel in the digital channels may be performed according to formula I:

CSS=[(embedding(wi))×W1]+[CS×W2]+[CPS×W3], (I)
whereby:
embedding (wi) is a contextual embedding value of wi,
CS is Channel Sentiment score that is calculated based on sentiment analysis of the AI language model through Generative Adversarial Networks (GANs) processing,
CPS is Channel Probability score that is derived by an ensemble learning technique, and W1, W2 and W3 are preconfigured weights and their total sum equals ‘1’.

According to some embodiments of the present disclosure, the generator and discriminator training of the GANs processing is operated by the generator network that is continuously creating synthetic interaction data or embeddings that mimic the actual data, e.g., sentiment data derived from interactions and the discriminator network differentiates between real interaction data and synthetic data that has been generated by the generator network.

According to some embodiments of the present disclosure, the discriminator network is simultaneously updated to better distinguish between real and synthetic data. This adversarial process continues until the generator produces embeddings that are indistinguishable from real data, resulting in improved sentiment analysis for calculating the CSS.

According to some embodiments of the present disclosure, the CPS represents the likelihood of a specific digital channel being the most effective for a given campaign based on past interaction data and contextual embeddings. Effectiveness relates to the conversion rate to the product or service of the tenant.

According to some embodiments of the present disclosure, the ensemble learning technique may be for example, Boosting (AdaBoost) ensemble learning technique. AdaBoost combines multiple weak classifiers e.g., simple decision trees or rules to create a strong classifier. For the interaction data, each classifier may be trained on the data, focusing on different aspects like response time, customer preference, and historical success rates, e.g., conversion rates. Misclassified data points are given higher weights in the next iteration to improve accuracy. The final CPS is an ensemble score derived from the weighted outputs of all classifiers.

According to some embodiments of the present disclosure, the one or more processors 110 may be further configured to send a notification to applications of the tenant with details of the CSS of each digital channel and the selected digital channel. The applications may be for example, supervisor dashboard, reporting, Quality Management (QM) application, and gamification application.

According to some embodiments of the present disclosure, the one or more processors 110 may be further configured to monitor a conversion rate for a preconfigured period of time that the outbound campaign communication was redirected to the selected digital channel When the conversion rate of the campaign is below a target-threshold after the preconfigured period of time, the one or more processors 110 may be further configured to initiate a targeted agent training programs for agents assigned to the outbound campaign communication.

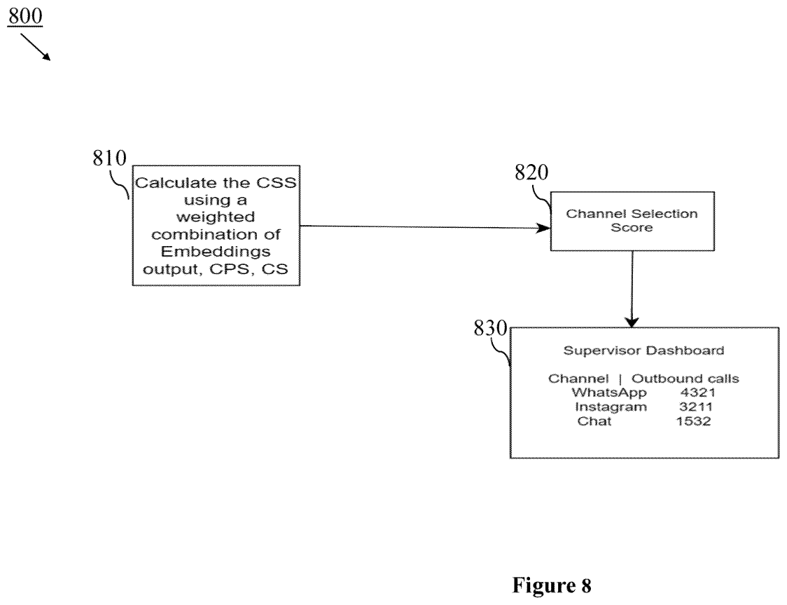

According to some embodiments of the present disclosure, optionally, the CSS of each digital channel and the number of interactions that were redirected to the selected digital channel may be presented via the supervisor dashboard of the tenant. For example, as shown in FIG. 8.

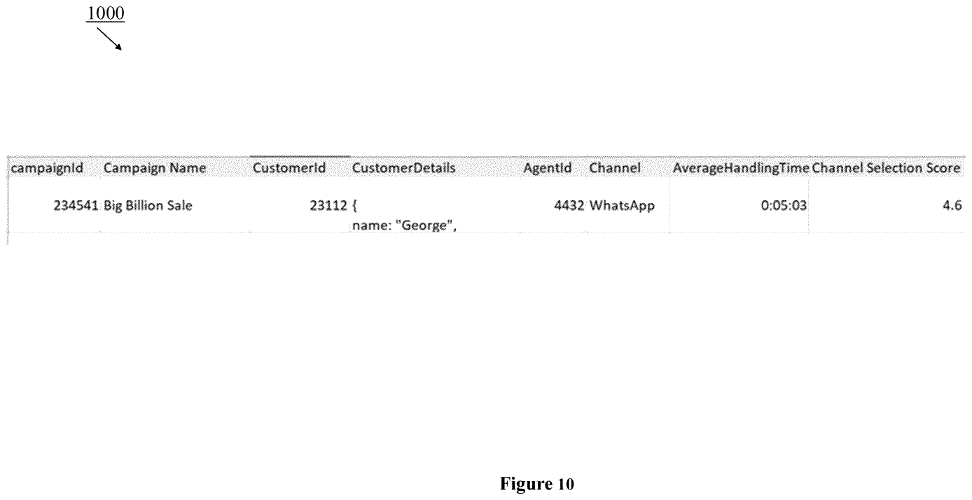

According to some embodiments of the present disclosure, optionally, the CSS of each digital channel may be presented via the reporting with campaign data and interaction data. For example, as shown in FIG. 10.

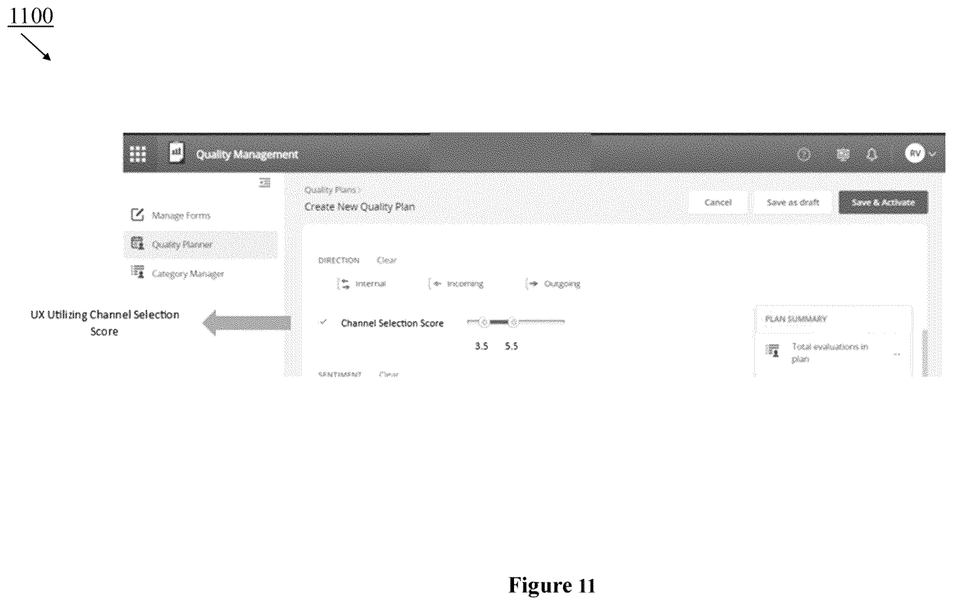

According to some embodiments of the present disclosure, the one or more processors 110 may be further configuring the QM application to filter interactions of the outbound campaign communication for an evaluation, based on a range of the CSS. For example, as shown in FIG. 11.

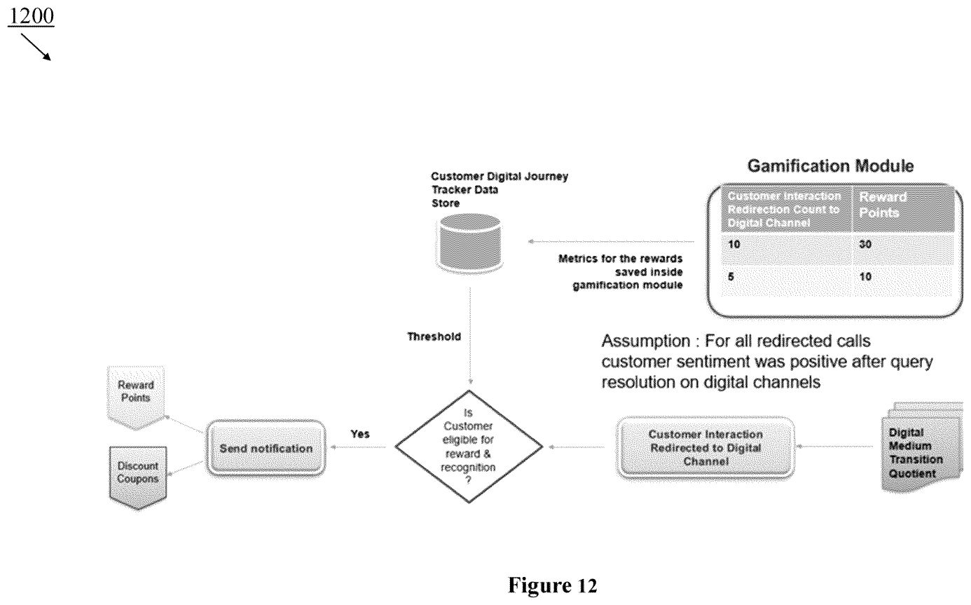

According to some embodiments of the present disclosure, the one or more processors 110 may be further configuring the gamification application to automatically send reward points to agents assigned to the outbound campaign communication when based on conversion rate and CSS. For example, as shown in FIG. 12.

According to some embodiments of the present disclosure, for example, when an outbound campaign for a new product achieves a conversion rate of 30%, which may be above the configured target threshold of 20%, and the calculated CSS of 0.85 on a scale of ‘0’ to ‘1’ for the Email channel. Agents who handled the interactions associated with this channel may receive reward points, such as: 100 points for exceeding the target conversion rate by 10%, 50 points for maintaining a high CSS in their assigned channel, which may incentivize agents to maintain quality and productivity in their campaigns. High CSS may be a CSS above a predefined threshold.

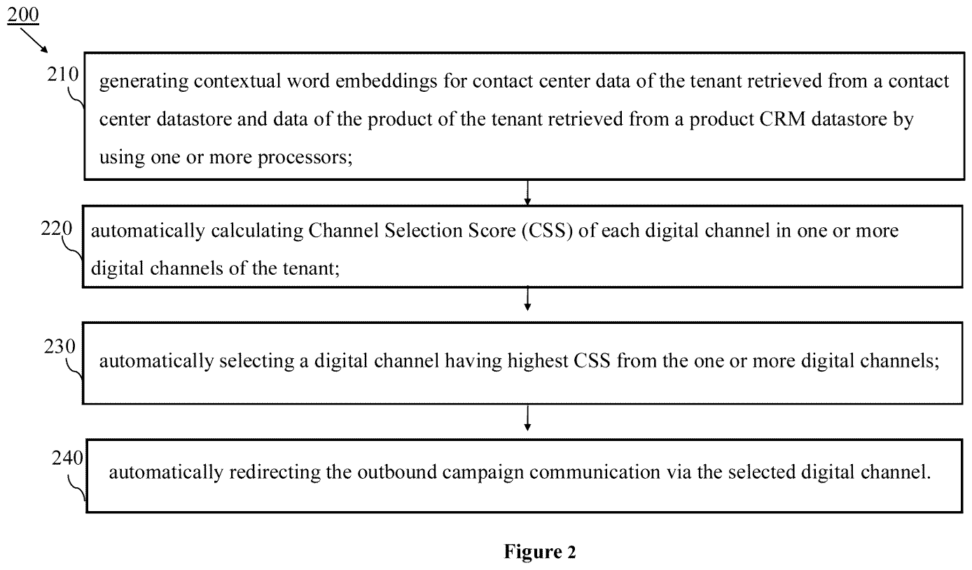

FIG. 2 schematically illustrates a high-level diagram of a computerized-method 200 for generative artificial intelligence based digital channel selection of outbound campaign communication, to a product of a tenant, in a cloud-based contact center, in accordance with some embodiments of the present invention.

According to some embodiments of the present disclosure, in a system, such as system 100 in FIG. 1, computerized-method 200 may be operated in real-time for each outbound interaction during a campaign.

According to some embodiments of the present disclosure, operation 210 comprising generating contextual word embeddings for contact center data of the tenant retrieved from a contact center datastore and data of the product of the tenant retrieved from a product CRM datastore by using one or more processors.

According to some embodiments of the present disclosure, operation 220 comprising automatically calculating a Channel Selection Score (CSS) of each digital channel in one or more digital channels of the tenant.

According to some embodiments of the present disclosure, operation 230 comprising automatically selecting a digital channel having highest CSS from the one or more digital channels.

According to some embodiments of the present disclosure, operation 240 comprising automatically redirecting the outbound campaign communication via the selected digital channel.

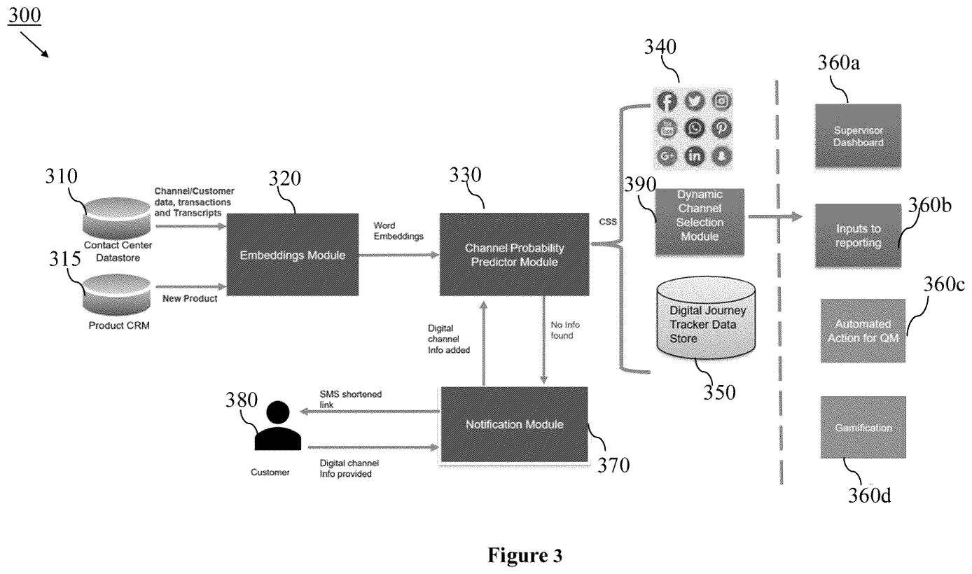

FIG. 3 schematically illustrates a high-level diagram 300 of a computerized-system for generative artificial intelligence based digital channel selection of outbound campaign communication, to a product of a tenant, in a cloud-based contact center, in accordance with some embodiments of the present invention.

According to some embodiments of the present disclosure, for each outbound interaction during a campaign, a system, such as system 100 in FIG. 1, may analyze data that is retrieved from the contact center datastore 310 of the tenant by utilizing various parameters, such as channel customer data, transactions e.g., result of the outbound campaign communication and transcripts of interactions. Word embeddings for both existing data and descriptions of new products retrieved from the product CRM datastore 315, may be generated. Word embeddings are dense vector representations of words in a high-dimensional space, where each word is mapped to a unique vector. Word embeddings capture semantic similarities between words and are used to represent words in a continuous vector space, enabling neural networks to understand and process natural language more effectively.

According to some embodiments of the present disclosure, for example, the neural network technique for generating word embeddings that may be implemented may be Word2Vec which employs neural networks and Generative AI.

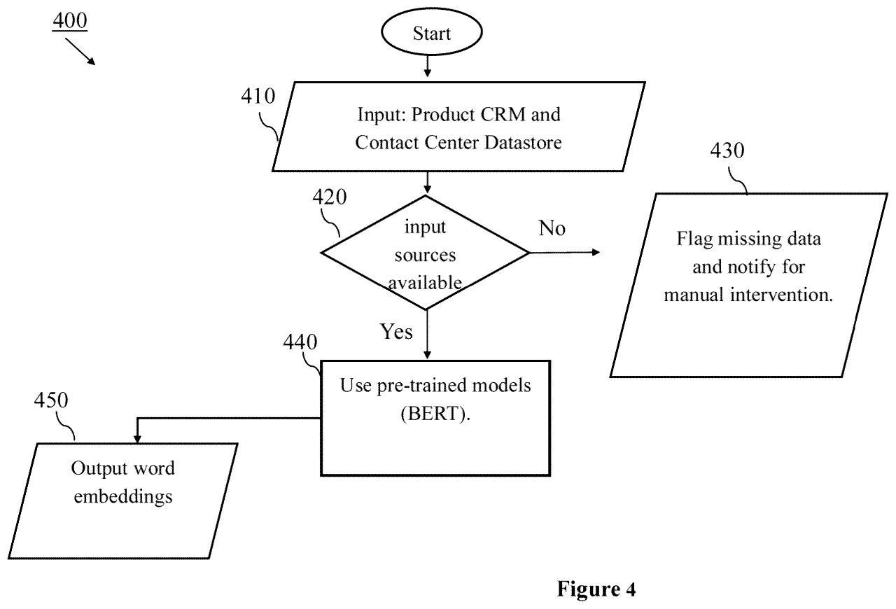

According to some embodiments of the present disclosure, the contextual word embeddings may be generated for contact center data of the tenant which may be retrieved from the contact center datastore and data of the product of the tenant retrieved from the product CRM datastore. For example, the contextual word embeddings may be generated by an embeddings module 320, as shown in FIG. 4, which may apply embedding generation logic by using pretrained models, such as BERT models. The contextual word embeddings may be generated for both customer and product data.

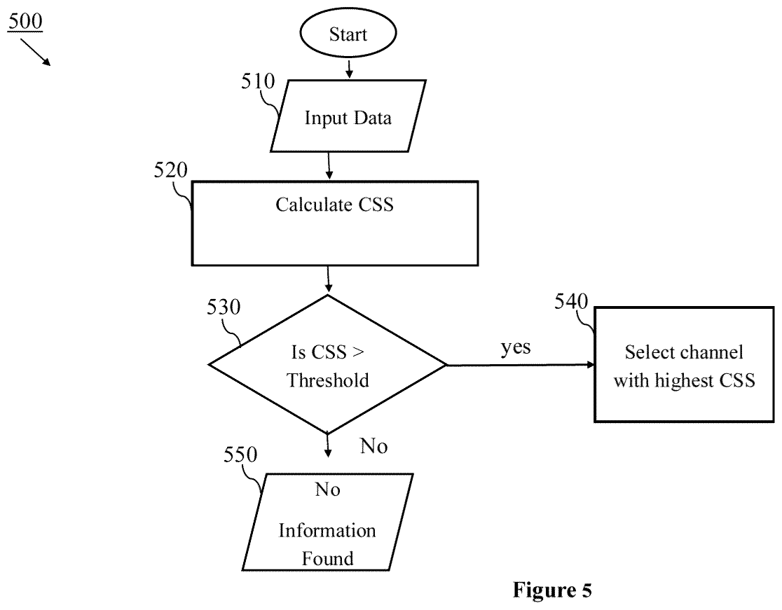

According to some embodiments of the present disclosure, the generated contextual word embeddings, historical channel performance data from contact center datastore 310 and tenant preferences and past behavior may be provided to a channel probability predictor module 330 which may operate as shown in FIG. 5. This module may calculate several scores to determine the optimal channel for each outbound interaction during the outbound campaign. Channel Sentiment (CS) score may be calculated by utilizing BERT advanced sentiment analysis through GANs processing to gauge the sentiment associated with each digital channel. Channel Probability Score (CPS) may be calculated by employing Adaptive Boosting (AdaBoost) to derive the Channel Probability Score.

According to some embodiments of the present disclosure, a CSS may be calculated for each digital channel of the tenant based on the CS and CPS by the following formula I:

CSS=[(Embedding(wi))×W1]+[CS×W2]+[CPS×W3], (I)
whereby:
embedding (wi) is a contextual embedding value of wi,
CS is Channel Sentiment score that is calculated based on sentiment analysis of the AI language model through Generative Adversarial Networks (GANs) processing,
CPS is Channel Probability Score that is derived by an ensemble learning technique, and W1, W2 and W3 are preconfigured weights and their total sum equals ‘1’.

According to some embodiments of the present disclosure, a module, such as dynamic channel selection module 390 may select the highest ranked channel, e.g., highest CSS for the product as the most suitable for the outbound campaign communication in each interaction.

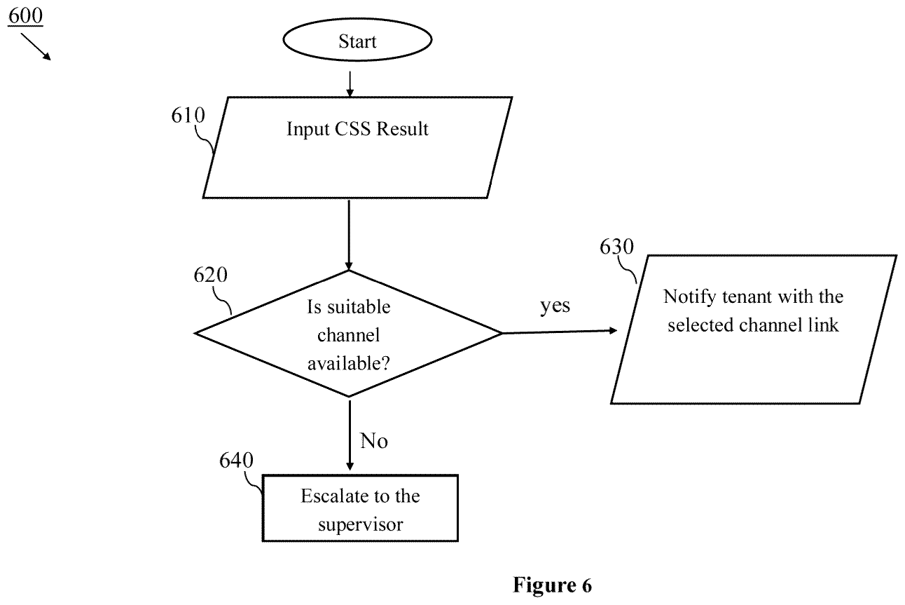

According to some embodiments of the present disclosure, a notification module 370 may handle the dissemination of messages, alerts, or updates to tenants through their preferred digital channels, for example, as shown in FIG. 6. It may ensure timely and personalized communication with tenants based on their interaction history, preferences, and campaign objectives.

According to some embodiments of the present disclosure, for example, an SMS notification module may send SMS notifications to tenants with a brief message or call-to-action along with a shortened link. The shortened link may direct tenants to a landing page or preferred digital channel where they can engage further with the content or take desired actions.

According to some embodiments of the present disclosure, a preference consideration module may consider tenant's preferred digital channel, as inferred from their interaction history or explicitly stated preferences, to determine the most appropriate channel for notification delivery.

According to some embodiments of the present disclosure, the dynamic channel selection module 390 may store information as to tenant's digital journey to assess conversion rates in a digital journey tracker data store.

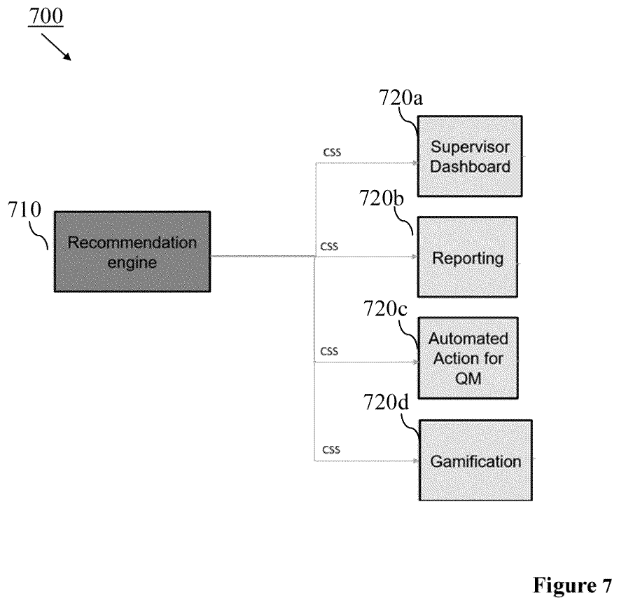

According to some embodiments of the present disclosure, the CSS may be forwarded to at least one application, as shown in FIG. 7. For example, supervisor dashboard 360a, e.g., as shown in FIG. 8, reporting 360b, e.g., as shown in FIG. 10, automated action for QM application 360c, as shown in FIG. 11 and gamification application 360d, as shown in FIG. 12.

FIG. 4 schematically illustrates a high-level workflow 400 for generating contextual word embeddings, in accordance with some embodiments of the present invention.

According to some embodiments of the present disclosure, the embedding module may receive data from the product CRM datastore and the contact center datastore 410. When the input is available 420 the data may include word embeddings from the embeddings module, such as embeddings module 320 in FIG. 3, historical channel performance data from the contact center datastore and customer preferences and past behavior. When the input source is not available, missing data may be flagged, and manual intervention may be notified 430.

According to some embodiments of the present disclosure, pretrained BERT modules may be used to the output contextual word embeddings 440.

According to some embodiments of the present disclosure, contextual word embeddings may be generated 450.

FIG. 5 schematically illustrates a high-level workflow 500 for calculating a Channel Selection Score (CSS), in accordance with some embodiments of the present invention.

According to some embodiments of the present disclosure, a channel probability predictor module, such as channel probability predictor module 330 in FIG. 3, may receive input data 510 to calculate the following scores to determine the optimal channel for the outbound campaign for the tenant.

According to some embodiments of the present disclosure, product keywords and customer profiles may be matched with available channels for outbound campaign communication.

According to some embodiments of the present disclosure, the Channel Selection Score (CSS) may be calculated 520 based on formula I:

$$CSS = [ ( Embedding ( wi ) ) \times W 1 ] + [ CS \times W 2 ] + [ CPS \times W 3 ] , \qquad ( I )$$

whereby:
embedding (wi) is a contextual embedding value of wi,
CS is Channel Sentiment score that is calculated based on sentiment analysis of the AI language model through Generative Adversarial Networks (GANs) processing,
CPS is Channel Probability score that is derived by an ensemble learning technique, and W1, W2 and W3 are preconfigured weights and their total sum equals ‘1’.

According to some embodiments of the present disclosure, the CSS of each digital channel may be compared to a threshold 530 and ranked. The highest ranked channel may be selected for the product 540.

According to some embodiments of the present disclosure, when there is no channel with CSS greater than the threshold, the tenant may receive a message that no information has been found 550.

FIG. 6 schematically illustrates a high-level workflow 600 for digital channel selection based on the CSS, in accordance with some embodiments of the present invention.

According to some embodiments of the present disclosure, in a system, such as system 100 in FIG. 1, input CSS result 610 may be the CSS calculated for all digital channels of the tenant for the campaign outbound communication for each interaction of the outbound campaign. The digital channel with highest score may be selected and checked if it is available 620. When the digital channel is available, then the outbound campaign may automatically commence with the selected digital channel.

According to some embodiments of the present disclosure, optionally, the tenant may be notified with the selected digital channel 630. When there is not enough data available to calculate CSS, tenant may be notified with a shortened link to a webpage where the digital channel may be specified.

According to some embodiments of the present disclosure, optionally, in case the selected digital channel is not available, escalating the case to the supervisor.

FIG. 7 illustrates automated actions 700 based on the CSS, in accordance with some embodiments of the present invention.

According to some embodiments of the present disclosure, optionally, a recommendation module 710 may distribute the CSS of each digital channel to one or more applications which may automatically act based on the received CSS.

According to some embodiments of the present disclosure, the CSS may be forwarded to a supervisor dashboard 720a, to provide key statistics as to most effective digital channel for the outbound campaign for a specific product of the tenant, for example as shown in FIG. 8.

According to some embodiments of the present disclosure, the CSS may be also distributed to a reporting module 720b, for example, as shown in FIG. 10, to display the priority of digital channels for an outbound campaign for a specific product of the tenant.

According to some embodiments of the present disclosure, the CSS may be also distributed to a QM application 720c along with conversion rate during the outbound campaign of the product, and when the conversion rate may be lower than a predefined threshold despite the optimized digital channel, i.e., digital channel having highest CSS, then the agents which are assigned to the outbound campaign may be automatically scheduled for a training session. For example, as shown in FIG. 11.

According to some embodiments of the present disclosure, the CSS may be also distributed to a gamification application 720d, for example, as shown in FIG. 12. When an agent may consistently reach a conversion rate higher than a preconfigured threshold during the outbound campaign and the interactions have been redirected based on highest CSS the agent may be eligible for a reward via the gamification application.

FIG. 8 illustrates implementation of a CSS in a supervisor dashboard 800, in accordance with some embodiments of the present invention.

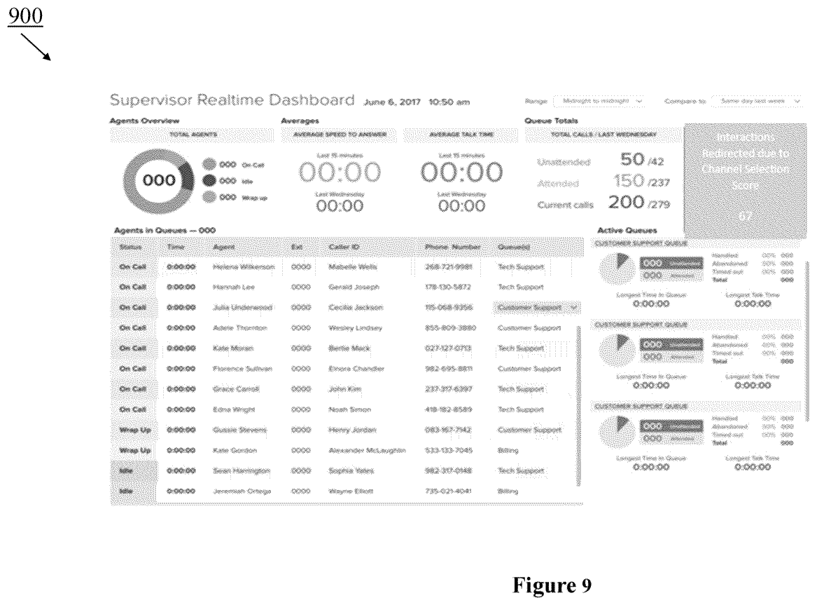

According to some embodiments of the present disclosure, in a system, such as system 100 in FIG. 1, the calculated CSS of each digital channel of the tenant may be forwarded to a supervisor dashboard. For example, as shown in FIG. 9.

According to some embodiments of the present disclosure, the calculated CSS of each digital channel in one or more digital channels of the tenant based on the generated contextual embeddings 810 may be forwarded to a channel selection score module 820.

According to some embodiments of the present disclosure, the supervisor dashboard 830 may be used as a central hub for supervisors, offering real-time insights into the most effective channels for reaching target audiences.

FIG. 9 is an example of supervisor dashboard 900 showing interactions redirected based on CSS, in accordance with some embodiments of the present invention.

According to some embodiments of the present disclosure, in a system, such as system 100 in FIG. 1, outbound campaign communication may be redirected based on the CSS that may be calculated for each digital channel of the tenant. The number of interactions redirected based on CSS may be shown in real-time via the supervisor dashboard 900.

FIG. 10 is an example of reporting 1000 of an outbound campaign details including CSS, in accordance with some embodiments of the present invention.

According to some embodiments of the present disclosure, a reporting, such as reporting 1000 may be presented to a user of the tenant. A record in the reporting may include the outbound campaign ID, the campaign name, tenant ID, an agent ID, a KPI such as Average Handling Time (AHT) the digital channel, e.g., WhatsApp and the CSS.

FIG. 11 illustrates implementation of CSS in Quality Management (QM) application, in accordance with some embodiments of the present invention.

According to some embodiments of the present disclosure, User Interface (UI) 1100 may be for example, a UI of a QM application via which the Channel Selection Score (CSS) parameter may be configurable for filtering interactions for evaluation.

According to some embodiments of the present disclosure, when the conversion rates during an outbound campaign may fall below a preconfigured threshold despite the configured CSS parameter, e.g., optimized channel selection, an automated action may be triggered via the QM application, to initiate targeted agent training programs to address identified deficiencies and enhance performance.

According to some embodiments of the present disclosure, optionally, the QM application may distribute only recorded calls in which the CSS is in a certain range, in addition to other scores, such as customer sentiment, agent sentiment, first call resolution, customer feedback for evaluation. The CSS may act as a data-point for the evaluator to perform evaluations for the specific range of channel selection score.

FIG. 12 illustrates implementation of CSS in gamification application 1200, in accordance with some embodiments of the present invention.

According to some embodiments of the present disclosure, the gamification application may be designed to boost agent motivation and productivity. Agents receive tangible rewards or recognition for each successful outbound call, fostering a competitive and engaging work environment.

According to some embodiments of the present disclosure, the gamification is performed when agent gets some rewards on success of every outbound call being made to motivate them.

According to some embodiments of the present disclosure, the gamification application may ensure that required rewards and recognitions are provided to agent as part of successful outbound calls as to customers get converted to sign up for the product in question.

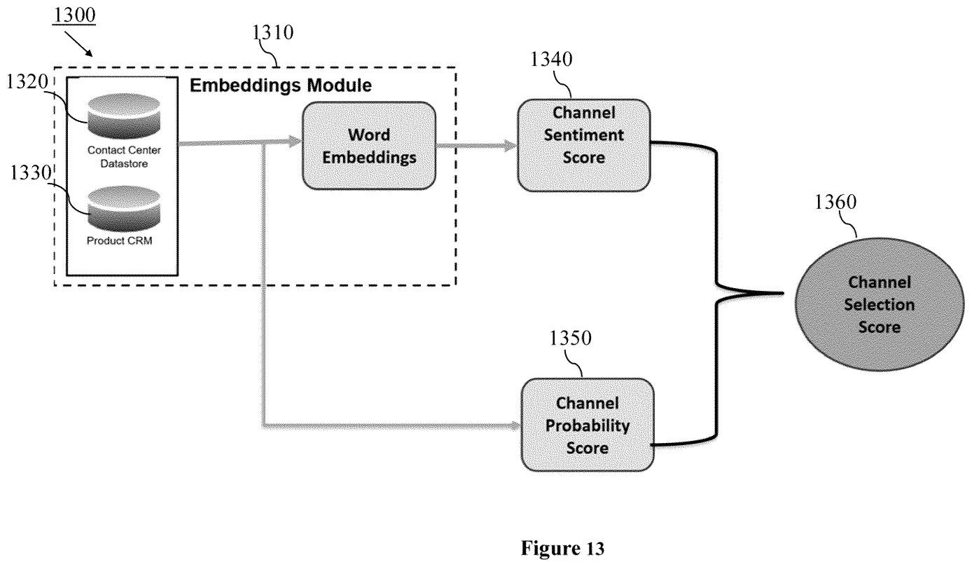

FIG. 13 is a high-level workflow 1300 for digital channel selection, in accordance with some embodiments of the present invention.

According to some embodiments of the present disclosure, an embeddings module may generate word embeddings which represents keywords from Generative AI output and new product description as word embeddings using neural networks, such as Word2Vec.

According to some embodiments of the present disclosure, the generating of the contextual word embeddings may be performed by using neural networks to capture word-level semantics and a continuously trained Artificial Intelligence (AI) language model to capture context-sensitive embeddings.

According to some embodiments of the present disclosure, the contact center data retrieved from the contact center datastore 1320 may include interactions-data related to outbound campaign communication during a preconfigured period. The interactions-data may include at least one of digital channel used, customer data, result of the outbound campaign communication, and transcript. The data of the product retrieved from the product CRM datastore may include description of the product which is the subject of the outbound campaign of the tenant.

According to some embodiments of the present disclosure, a channel sentiment score (CS) 1340 may be calculated based on sentiment analysis of the AI language model through Generative Adversarial Networks (GANs) processing. For example, BERT advanced sentiment analysis technique may be used to calculate channel sentiment score, from customer's point of view, by processing GANs.

According to some embodiments of the present disclosure, the channel probability score 1350 may be derived by an ensemble learning technique. For example, Adaptive Boosting (AdaBoost), may be used to combine the predictions of multiple models and improve the overall accuracy of channel selection score 1360.

According to some embodiments of the present disclosure, the calculating of the CSS 1360 of each digital channel in the one or more digital channels may be performed according to formula I:

$$CSS = [ ( embedding ( wi ) ) \times W 1 ] + [ CS \times W 2 ] + [ CPS \times W 3 ] , \qquad ( I )$$

whereby:
embedding (wi) is a contextual embedding value of wi,
CS is Channel Sentiment score that is calculated based on sentiment analysis of the AI language model through Generative Adversarial Networks (GANs) processing,
CPS is Channel Probability score that is derived by an ensemble learning technique, and W1, W2 and W3 are preconfigured weights and their total sum equals ‘1’.

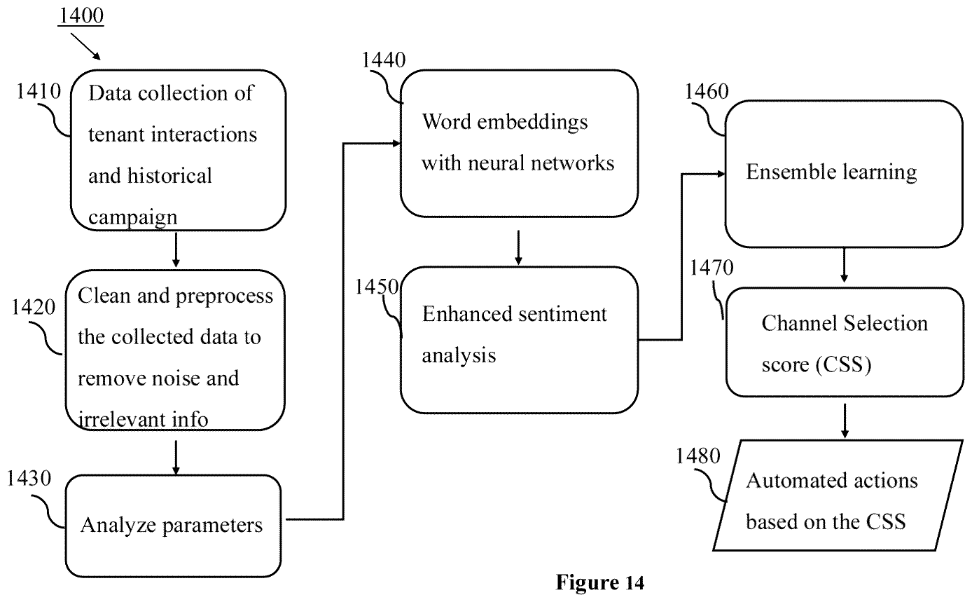

FIG. 14 schematically illustrates a high-level workflow 1400 for generative artificial intelligence based digital channel selection of outbound campaign communication, to a product of a tenant, in a cloud-based contact center, in accordance with some embodiments of the present invention.

According to some embodiments of the present disclosure, in a system, such as system 100 in FIG. 1, the ‘data collection’ phase 1410 to generate contextual word embeddings for contact center data of the tenant may be data collection of tenant interactions and historical campaign data of similar products to the product of the tenant which is the subject of the outbound campaign. The data may be retrieved from the contact center datastore and data of the product of the tenant retrieved from the product CRM datastore.

According to some embodiments of the present disclosure, relevant data sources may be identified, such as customer interactions, campaign logs, CRM. Raw data may be extracted from these sources using APIs or manual uploads. Data validation may be operated to verify data integrity, completeness and accuracy. The data may be stored in a structured format for further analysis.

According to some embodiments of the present disclosure, after the data collection, as part of preprocessing phase, cleaning and preprocess of the collected data to remove noise and irrelevant information 1420 may be operated. The contact center data retrieved from the contact center datastore, and the data of the product retrieved from the product CRM datastore may be cleaned and normalized before the generating of word embeddings. The raw dataset may be loaded and then noise removal may be operated to remove rows and columns with excessive, missing values and filter out irrelevant data points. Data transformation may be applied by normalizing text data, e.g., lowercase, and removal of special characters and by standardizing numerical data, e.g., scaling and log transformation.

According to some embodiments of the present disclosure, features may be selected by analyzing feature relevance and retaining only the top ‘n’ features, the feature relevance analysis may be operated by using statistical tests or feature importance scores.

According to some embodiments of the present disclosure, data enrichment may be performed by imputing missing values using mean, median or predictive models and merging external datasets if needed.

According to some embodiments of the present disclosure, the cleaning and preprocess of the dataset may be followed by parameter analysis 1430 to analyze parameters, such as, customer preferences, channel effectiveness, campaign objectives and the like.

According to some embodiments of the present disclosure, during the parameter analysis, tenant segmentation may be performed. The tenant segmentation may be performed by applying clustering algorithms, e.g., K-Means to group tenants and analyzing each tenant segment for key characteristics.

According to some embodiments of the present disclosure, each digital channel effectiveness may be evaluated by aggregating historical data by channel and calculating performance metrics, such as response rate and conversion rate. Campaign objectives may be mapped by defining key objectives, e.g., increase engagement and drive dales, and by matching objectives with insights from segmentation and channel analysis.

According to some embodiments of the present disclosure, the generated actionable insights for decision-making may be stored in a datastore.

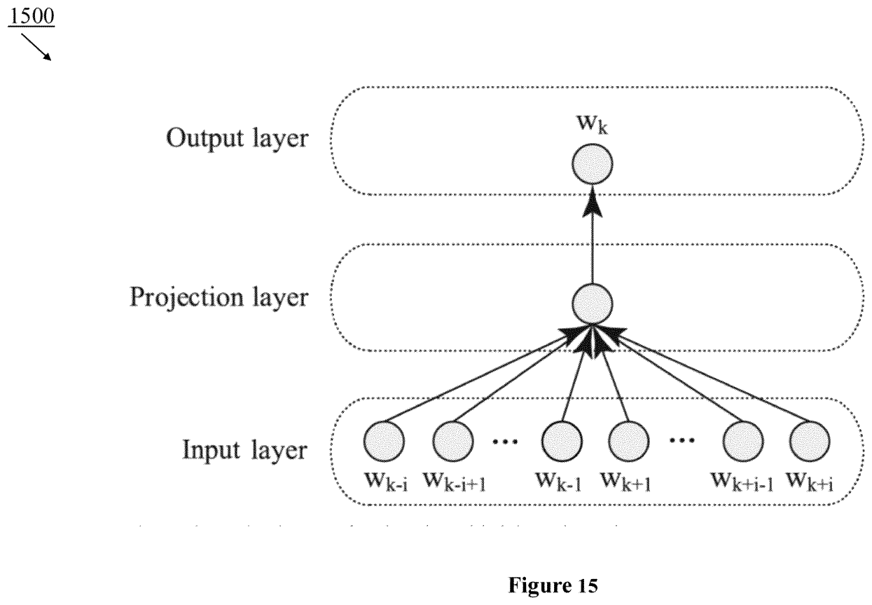

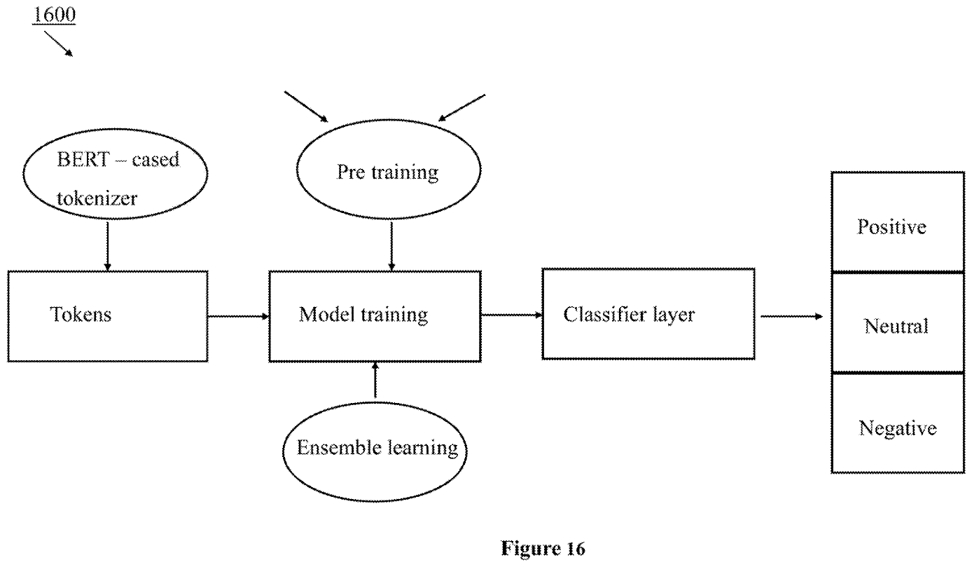

According to some embodiments of the present disclosure, word embeddings, as shown in FIG. 15, may be generated with neural networks 1440, such as Word2Vec neural networks and Gen AI. An enhanced sentiment analysis 1450 may be operated to apply fine-tuned BERT models for sentiment analysis, for example, as shown in FIG. 16.

According to some embodiments of the present disclosure, ensemble learning 1460 may be operated to combine predictions from GANs, sentiment analysis and dynamic segmentation. The Channel Selection Score (CSS) may be calculated using weighted combination of embeddings output, CPS, CS.

According to some embodiments of the present disclosure, the CS may be calculated in context of digital channels for example, by using BERT sentiment analysis technique.
CS=Bert(Embedding(wi)).
CS is the channel sentiment score.
BERT represents the fine-tuned BERT model for sentiment analysis.
x1,x2, . . . ,xn is the output of the Generative Adversarial Networks trained on word embeddings of keywords.

According to some embodiments of the present disclosure, the ensemble learning may include combining models to create a stronger model. It may be operated by training multiple models on different subsets of the training data or using different algorithms and then combining the predictions of these models to make the final prediction. There are several types of ensemble learning techniques, including bagging, boosting, and stacking.

According to some embodiments of the present disclosure, the ensemble learning may be operated for example, as follows:
Let H1, H2, . . . ,Hn represent the weak classifiers e.g., decision trees, trained using AdaBoost.
Let a1, a2, . . . ,an represent the weights assigned to each weak classifier.
Then, the formula for calculating the CPS may be represented as:
ai is the weight assigned to weak classifier Hi.
n is the total number of weak classifiers.
Each weak classifier Hi provides a prediction, and the AdaBoost algorithm assigns a weight ai to each classifier based on its performance. The final CPS is computed by combining these weighted predictions. Weights (ai) are adjusted based on the performance of each weak classifier in the ensemble.

According to some embodiments of the present disclosure, based on the calculated CSS, digital channels for outbound campaigns may be prioritized 1480.

FIG. 15 schematically illustrates a diagram 1500 for word embeddings, in accordance with some embodiments of the present invention.

According to some embodiments of the present disclosure, the word embeddings with neural networks may represent keywords from Generative AI output and new product description as word embeddings using Word2Vec. It represents the embeddings generated for keywords (w1,w2, . . . , wn) associated with the product and channels.
Embedding (wi)=Word2Vec (w1,w2, . . . wn).

FIG. 16 schematically illustrates an enhanced sentiment model 1600, in accordance with some embodiments of the present invention.

According to some embodiments of the present disclosure, for the enhanced sentiment model, BERT becomes one of the most important and complete architectures for various natural language tasks having generated results on sentence pair classification tasks, question-answer tasks, and the like.

According to some embodiments of the present disclosure, by simultaneously examining both sides of a word's context, BERT can capture a word's whole meaning in its context, in contrast to earlier models that only considered the left or right context of a word. This enables BERT to deal with ambiguous and complex linguistic phenomena including polysemy, co-reference, and long-distance relationships.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

1. A computerized-system for generative artificial intelligence based digital channel selection of outbound campaign communication that is directed to a product of a tenant, in a cloud-based contact center, said computerized-system comprising:
a contact center datastore;
a product Customer Relationship Management (CRM) datastore;
a memory to store the plurality of datastores; and
one or more processors, for each interaction of the outbound campaign, said one or more processors are configured to:
(i) retrieve, from the contact center datastore, contact center data comprising interactions-data related to outbound campaign communication during a preconfigured period, wherein said interactions-data includes at least one of: (a) digital channel used; (b) customer data; (c) result of the outbound campaign communication; and (d) transcript, and retrieve, from the product CRM datastore, data of the product comprising a description of the product;
(ii) clean and normalize the retrieved contact center data and the retrieved data of the product;
(iii) generate contextual word embeddings for contact center data of the tenant retrieved from the contact center datastore and data of the product of the tenant retrieved from the product CRM datastore by using neural networks to capture word-level semantics and a continuously trained Artificial Intelligence (AI) language model to capture context-sensitive embeddings,
wherein the neural networks comprise Word2Vec and the AI language model comprises a Bidirectional Encoder Representations from Transformers (BERT) model;
(iv) generate, for each digital channel in one or more digital channels of the tenant, a Channel Sentiment (CS) score based on sentiment analysis of the generated contextual word embeddings through Generative Adversarial Networks (GANs) processing, and a Channel Probability Score (CPS) derived by an ensemble learning technique from past interaction data and the generated contextual word embeddings;
(v) calculate a Channel Selection Score (CSS) of each digital channel in one or more digital channels of the tenant based on the generated contextual embeddings, the CS score, and the CPS;
(vi) compare the CSS of each digital channel to a threshold and rank the one or more digital channels according to the compared CSS;
(vii) select a digital channel having highest CSS from the ranked one or more digital channels and check whether the selected digital channel is available;
(viii) automatically redirect the outbound campaign communication via the selected digital channel when the selected digital channel is available;
(ix) when an input source is not available, flag missing data and notify manual intervention, and when no digital channel has a CSS greater than the threshold or when the selected digital channel is not available, generate a message indicating that no information has been found or escalate to a supervisor;
(x) store information identifying the selected digital channel in a digital journey tracker data store to assess conversion rates;
(xi) send a notification to one or more applications of the tenant with details of the CSS of each digital channel and the selected digital channel,
wherein the one or more applications are one of: (i) supervisor dashboard; (ii) reporting; (iii) Quality Management (QM); and (iv) gamification,
(xii) monitor a conversion rate for a preconfigured period of time that the outbound campaign communication was redirected to the selected digital channel, and
(xiii) when the conversion rate of the campaign is below a target-threshold after the preconfigured period of time, initiate targeted agent training programs for agents assigned to the outbound campaign communication.

2. The computerized-system of claim 1, wherein the contact center data retrieved from the contact center datastore comprising interactions-data related to outbound campaign communication during a preconfigured period, wherein said interactions-data includes at least one of: (i) digital channel used; (ii) customer data; (iii) result of the outbound campaign communication; and (iv) transcript, and
wherein the data of the product retrieved from the product CRM datastore comprising description of the product.

3. The computerized-system of claim 1, wherein the generating contextual word embeddings is performed by using neural networks to capture word-level semantics and a continuously trained Artificial Intelligence (AI) language model to capture context-sensitive embeddings.

4. The computerized-system of claim 1, wherein the contact center data retrieved from the contact center datastore, and the data of the product retrieved from the product CRM datastore are cleaned and normalized before the generating of word embeddings.

5. The computerized-system of claim 2, wherein the calculating of the CSS of each digital channel in the one or more digital channels is performed according to formula I:
$$CSS = [ ( embedding ( wi ) ) \times W 1 ] + [ CS \times W 2 ] + [ CPS \times W 3 ] , \qquad ( I )$$
whereby:
embedding (wi) is a contextual embedding value of a selected keyword wi,
the selected keyword is a keyword associated with the product and a respective digital channel,
CS is Channel Sentiment score that is calculated based on sentiment analysis of the AI language model through Generative Adversarial Networks (GANs) processing,
CPS is Channel Probability score that is derived by an ensemble learning technique, and W1, W2 and W3 are preconfigured weights and their total sum equals ‘1’.

6. (canceled)

7. The computerized-system of claim 1, wherein the CSS of each digital channel and the number of interactions that were redirected to the selected digital channel are presented via the supervisor dashboard of the tenant.

8. The computerized-system of claim 1, wherein the CSS of each digital channel is presented via the reporting with campaign data and interaction data.

9. (canceled)

10. The computerized-system of claim 1, wherein the one or more processors are further configuring the QM application to filter interactions of the outbound campaign communication for evaluation based on a range of the CSS.

11. The computerized-system of claim 1, wherein the one or more processors are further configuring the gamification application to automatically send reward points to agents assigned to the outbound campaign communication based on conversion rate and CSS.

12. A computerized-method for generative artificial intelligence based digital channel selection of outbound campaign communication that is directed to a product of a tenant, in a cloud-based contact center, said computerized-method comprising:
for each interaction of the outbound campaign:
(i) retrieving, from a contact center datastore, contact center data comprising interactions-data related to outbound campaign communication during a preconfigured period, wherein said interactions-data includes at least one of: (a) digital channel used; (b) customer data; (c) result of the outbound campaign communication; and (d) transcript, and retrieving, from a product CRM datastore, data of the product comprising a description of the product;
(ii) cleaning and normalizing the retrieved contact center data and the retrieved data of the product by using one or more processors;
(iii) generating contextual word embeddings for contact center data of the tenant retrieved from a contact center datastore and data of the product of the tenant retrieved from a product CRM datastore by using one or more processors by using neural networks to capture word-level semantics and a continuously trained Artificial Intelligence (AI) language model to capture context-sensitive embeddings, wherein the neural networks comprise Word2Vec and the AI language model comprises a Bidirectional Encoder Representations from Transformers (BERT) model;
(iv) generating, for each digital channel in one or more digital channels of the tenant, a Channel Sentiment (CS) score based on sentiment analysis of the generated contextual word embeddings through Generative Adversarial Networks (GANs) processing, and a Channel Probability Score (CPS) derived by an ensemble learning technique from past interaction data and the generated contextual word embeddings;
(v) automatically calculating a Channel Selection Score (CSS) of each digital channel in one or more digital channels of the tenant based on the generated contextual word embeddings, the CS score, and the CPS;
(vi) automatically comparing the CSS of each digital channel to a threshold and ranking the one or more digital channels according to the compared CSS;
(vii) automatically selecting a digital channel having highest CSS from the one or more digital channels after checking whether the selected digital channel is available;
(viii) automatically redirecting the outbound campaign communication via the selected digital channel when the selected digital channel is available;
(ix) when an input source is not available, flagging missing data and notifying manual intervention, and when no digital channel has a CSS greater than the threshold or when the selected digital channel is not available, generating a message indicating that no information has been found or escalating to a supervisor;
(x) storing information identifying the selected digital channel in a digital journey tracker data store to assess conversion rates
(xi) sending a notification to one or more applications of the tenant with details of the CSS of each digital channel and the selected digital channel,
wherein the one or more applications are one of: (i) supervisor dashboard; (ii) reporting; (iii) Quality Management (QM); and (iv) gamification
(xii) monitoring a conversion rate for a preconfigured period of time that the outbound campaign communication was redirected to the selected digital channel, and
(xiii) when the conversion rate of the campaign is below a target-threshold after the preconfigured period of time, initiating targeted agent training programs for agents assigned to the outbound campaign communication.
